(19) United States
(12) Patent Application Publication
(10) Pub. No.: US 2003/0116001 A1
(43) Pub. Date: Jun. 26, 2003

(54) Magnetic template

(76) Inventor: Jolynn Potter, Layton, UT (US)

Correspondence Address: MORRISS, BATEMAN, O'BRYANT & COMPAGNI, 136 SOUTH MAIN STREET, SUITE 700, SALT LAKE CITY, UT, 84101, US

(21) Appl. No.: 10/288,267

(22) Filed: Nov. 5, 2002

Related U.S. Application Data
(60) Provisional application No. 60/346,110, filed on Nov. 7, 2001.

(51) Int. Cl. B26D 7/27

(52) U.S. Cl. 83/522.11; 83/522.15

(57) ABSTRACT

A magnetic cutting board-template combination as disclosed for cutting paper into desired designs or drawing designs on the paper. The cutting board is preferably formed from a ferrous metal and the template is formed from a magnetic material so as to hold the paper to the cutting surface while the cut is performed.

### RELATED APPLICATIONS

The present application claims the benefit of U.S. Provisional Patent Application No. 60/346,110, filed Nov. 7, 2001.

### BACKGROUND OF THE INVENTION

1. Field of the Invention

The present invention relates to an apparatus and method for tracing and/or cutting shapes from paper and the like. Specifically, the present invention relates to a magnetized template/backboard combination which holds the template on a surface on which trace marks or cuts are being made in order to enable the tracing or cutting without holding on to the template.

2. State of the Art

There are many different forms of arts and crafts in which templates are used to mark material or paper, or to trace onto material or paper for later cutting, folding, etc. Typically, a person places a template on the surface to be marked or cut and holds the template in place with one hand. The other hand is then used to hold a pen or pencil or a cutting tool to trace the outline of the template and thereby mark the shape in the template on the piece of paper or material, or to cut the shape of the template from the paper or material.

While the use of templates in such a manner has been around for hundreds, if not thousands, of years, there are several disadvantages to this traditional method. First, the traditional method limits the ability of the user to use the hand holding the template for other purposes. This can include holding a surface on which the material or paper is being placed, reaching for other templates, or otherwise using the hand. Additionally, for those who have handicaps or missing limbs, it is often difficult to hold the template in place. Second, as the user moves a cutting tool around the template, there is always a risk that the hand holding the template in place will be cut by the cutting tool and thereby causing potentially serious injury to the user.

While numerous mechanisms have been configured to allow for the holding of templates, they usually require an arm or some other similar mechanism to engage the template. The arm typically extends into the path of the cutting or tracing instrument and it is often difficult to make a clean cut or trace without moving the template. Thus, the template must often be released from the surface to be traced on and cut, and then repositioned so that the arm, etc. does not interfere with the remainder of the tracing or cutting. This often requires the release of fasteners, and then refastening the fasteners once the template has been put in the new location.

Thus, there is a need for an improved mechanism for holding a template on a cutting surface. Such a configuration should hold the template securely while avoiding a requirement of any external member to hold the template in place while a piece of paper disposed under the template is cut. Additionally, it is preferred that the template and cutting surface can be removed from one another without the requirement of undoing fasteners, etc.

### SUMMARY OF THE INVENTION

It is an objection of the present invention to provide an improved template for cutting paper for crafts and/or for making drawings on paper.

The above and another object of the invention are achieved in a magnetic template combination comprising a cutting surface and a template which are magnetically attracted to one another so as to hold the template in place while a piece of paper resting between the template and cutting surface is cut.

In accordance with another aspect of the present invention, the cutting surface is formed of a ferrous metal and a template comprises a magnet. The template is drawn to the ferrous metal cutting surface to thereby hold the template in place while it is used.

In accordance with another aspect of the invention, the cutting surface is formed from a magnetized material and the template is formed from a ferrous metal. Thus the cutting surface is drawn to the template to hold the template in place on the cutting surface while the template is used.

In accordance with still yet another aspect of the invention, the cutting plate is at least four times larger, and preferably six times or more larger, than the template so that a plurality of templates can be disposed on a piece of paper held by the cutting surface and with each template being used to cut paper in a desired shape without moving the template or paper.

In accordance with yet another aspect of the invention, the magnetic templates are used to hold other, nonmagnetic templates in place while the user uses the nonmagnetic template to cut or draw on a piece of paper.

In accordance with yet another aspect of the present invention, a magnetic template has ruled markings disposed thereon to enable the user to measure the distance between drawings or cuttings on the piece of paper while the magnetic template is holding the piece of paper in place.

### BRIEF DESCRIPTION OF THE DRAWINGS

FIG. 1. shows a top view of a magnetic template-cutting surface combination in accordance with the principles of the present invention;

FIG. 1A shows a side view of the magnetic template-cutting surface combination of FIG. 1;

FIG. 2 shows a top view of a metal cutting surface having a plurality of templates disposed thereon in accordance with the principles of the present invention;

FIG. 3 shows a top view of a magnetic template having rules lines disposed thereon for measuring the locations of drawings or cuts in the paper;

FIG. 4 shows a plurality of templates used to hold a non-metallic template in place on a piece of paper and for holding the paper in place under the non-metallic template; and

FIG. 5 shows a ruled template used for holding down a piece of paper on the cutting surface, and a plurality of templates used to hold a non-metallic template over the paper.

### DETAILED DESCRIPTION

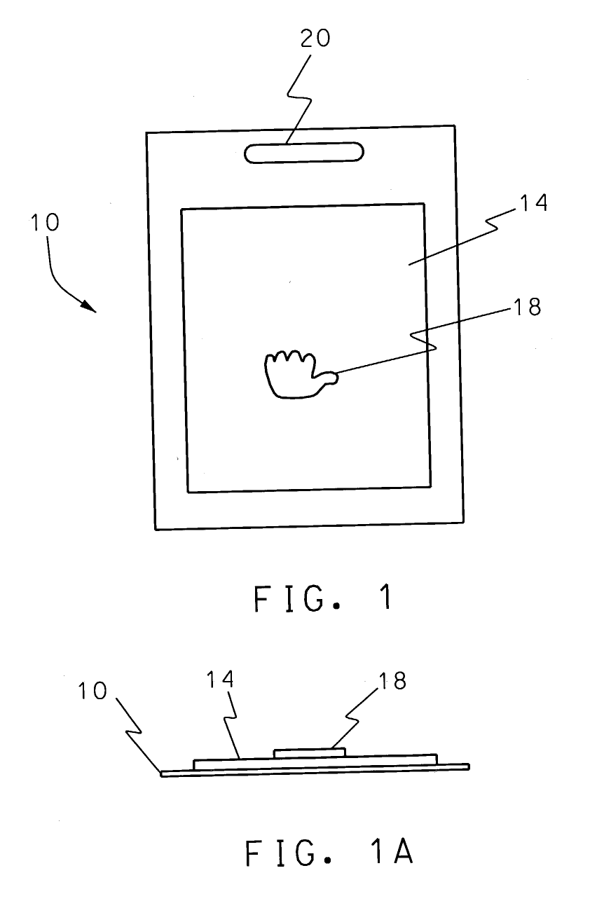

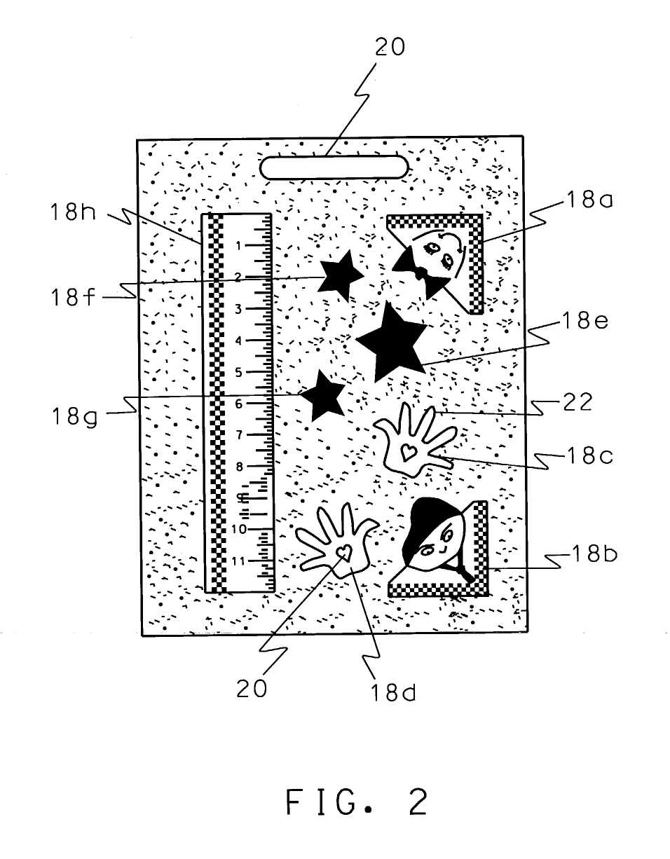

Referring to FIG. 1, there is shown a top view of a cutting surface generally indicated at 10. The cutting surface 10 is made from either a ferrous metal, such as steel or from a magnetic or magnetized material. In a preferred embodiment, the cutting surface 10 is made from steel, as steel will resist damage caused by cutting instruments coming into contact with the cutting surface. The cutting surface 10 also preferably has a hole 20 defining a handle for carrying the cutting surface.

Disposed on the cutting surface is a template 18 which is in the shape of a hand. The template is also made from a magnetized material or also has a magnetized material or ferrous metal selected to be magnetically attracted to the cutting surface 10. The attraction between the magnetic material and the ferrous metal is strong enough that the template 18 holds one or more pieces of paper 14 at a desired location on the cutting surface 10.

Because the template 18 is magnetically held to the cutting surface 10, a user is able to cut around the template without moving the template, without an attachment arm disposed in such a way as to interfere with use of the template, and without requiring the user to hold the template in place while cutting. By moving the user's non-working hand away from the cutting surface, the risk that the user will cut himself or herself with the cutting instrument is dramatically reduced. Additionally, because the other hand can be used to hold the cutting surface 10 in place, if need be, the cutting surface can be used both on flat surfaces, held on a person's lap, and/or held against walls, windows, etc. while keeping the cutting instrument away from the user's hand.

Turning now to FIG. 1A, there is shown a side view of the template 18 disposed above the cutting surface 10, and holding a piece of paper therebetween. It will be appreciated that the cutting surface 10 is preferably at least 8½ inches by 11, and preferably larger so that a full size sheet of paper 8½×11 inch paper can be held on the cutting surface with the edges of the cutting surface remaining visible. This prevents a person from accidently cutting himself or herself while cutting out a template because the template extends beyond the edge of the cutting surface.

Because the template 18 is in magnetic attraction with the cutting surface 10, a piece of paper 18 is securely held in place while it is being cut. Once the cut has been made around the template 14, the piece of paper can be removed without removing the template. In the alternative, the template 18 can be pulled away from the cutting surface 10 to thereby release the piece of paper 14 which has been cut.

While discussed above with respect to cutting, it will be appreciated that the template 18 can also be used for drawing shapes on the paper. The cutting surface forms a support surface for the paper 14 and the template. For convenience, however, the term cutting surface 10 will be used regardless of references to cutting or to drawing.

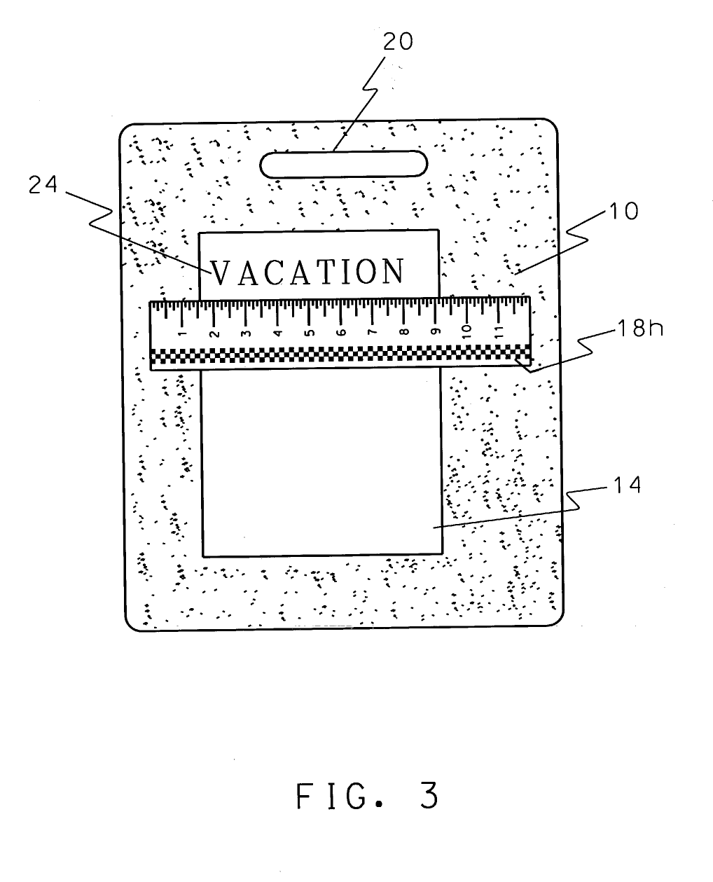

Turning now to FIG. 2, there is shown a top view of a cutting surface 10 having a plurality of templates 18a, 18b, 18c, 18d, 18e, 18f, 18g and 18h disposed thereon. It is preferred that the cutting surface 10 is at least four times the size of any of the templates 18. In a preferred embodiment, the cutting surface 10 is at least six times the size of any of the templates 18, so that a plurality of templates can be used to cut multiple designs from a single piece of paper without requiring repositioning of the paper or removal of any of the templates. In such a manner, a crafter can cut a plurality of different shapes on the cutting surface in a short amount of time. Additionally, a large size of the cutting surface 10 and making the cutting surface from a material such as steel, dramatically reduces the risk that the user will be cut during use of the cutting surface. It also allows the user to place the cutting surface on his or her lap or on surfaces which otherwise would not be used due to the risk of the cutting instrument cutting the same.

The templates 18 can also be used for drawing numerous shapes on a piece of paper without moving the templates and without moving the paper. Furthermore, as shown on template 18h, the templates may include ruled markings. The ruled markings enable a crafter to determine the distance between drawings and cuts without the need for an external ruler. Additionally, the rule template 18h prevents inaccurate measurements caused by movement of a non-magnetized ruler. When using a non-magnetized ruler (i.e. one that is not magnetically coupled to the cutting surface), it is common for the paper to move slightly each time the rule is repositioned and each time a person shifts the position of their hand. While seemingly small, these changes can lead to errors in spacing in the cuts or drawings, thereby requiring the user to start over with a new piece of paper.

The templates 18 can be formed in a variety of ways. Typically, the templates will be formed from a semi-flexible piece of magnetic material. Such materials are readily available and will be known to those or ordinary skill in the art. However, it will be appreciated that flexible magnetic materials can also be used. The magnetic material is cut into any desired shape such as stars and shapes representing people, or body parts such as hands and feet, etc., trees, balls, such as footballs, soccer balls, etc. Additionally, the template 18 can have a plurality of slots 22 formed therein so as to enable the template to have access to cuts therein so as to give the appearance of the desired object, i.e. accent markings or designs within the outer cuts of the design.

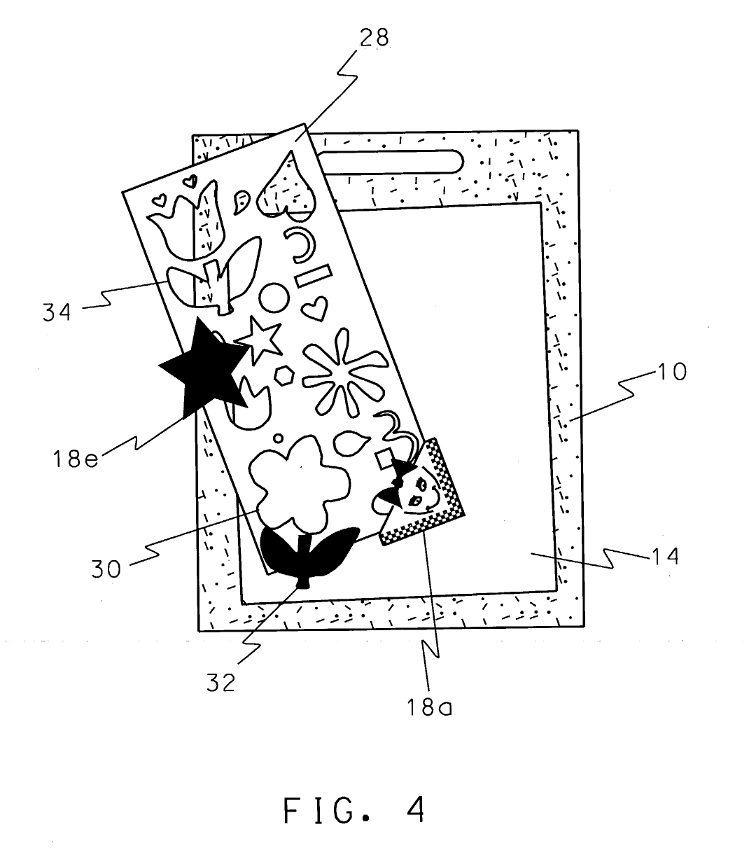

Turning now to FIG. 3, there is shown a top view of a cutting surface 10, having the ruler template 18h disposed thereon. In addition to being used for drawing or cutting a ruler on the piece of paper 14, the rule template 18h also securely holds the paper in place and allows for a user to measuring cuts or drawings, such as letting 24, to ensure that it is properly positioned on the paper. The ruler template 18h being magnetically held to the cutting surface 10 also prevents movement of the ruler, which is common when a ruler is simply placed on a piece of paper. Thus, as was mentioned above, the user can ensure that designs are spaced as desired and mistakes can be avoided.

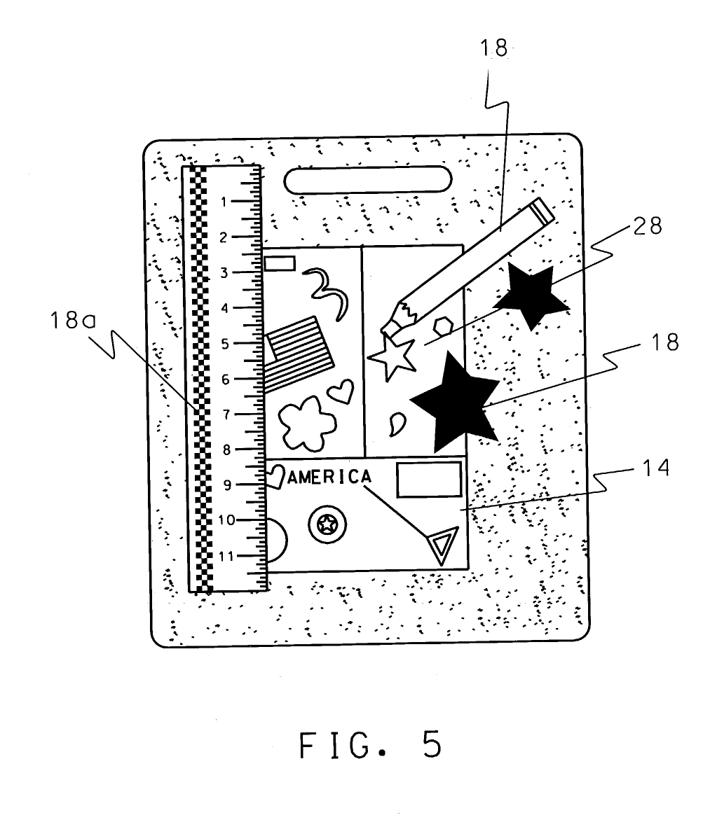

Turning now to FIG. 4, there is shown a top view of a pair of templates 18a and 18e holding a piece of paper 14 to the cutting surface 10. The templates 18a and 18e are also used to hold a drawing template 28 to the piece of paper 14. The magnetic templates 18a and 18e secure the non-magnetic template 28 in place so that a drawing or cut can be make on the paper 14 in a desired location. As shown in FIG. 4, the non-metallic template 28 includes an opening shaped as a flower 30 which is disposed above a drawing 32 of a flower stem. The stem 32 has previously been drawn by use of another opening 34 on the non-magnetic template 28.

The templates 18a and 18e enable the user to position the non-metallic template 28 in the desired location. Once in the desired location, the user can let go and concentrate on using the template 28, rather than holding it in place.

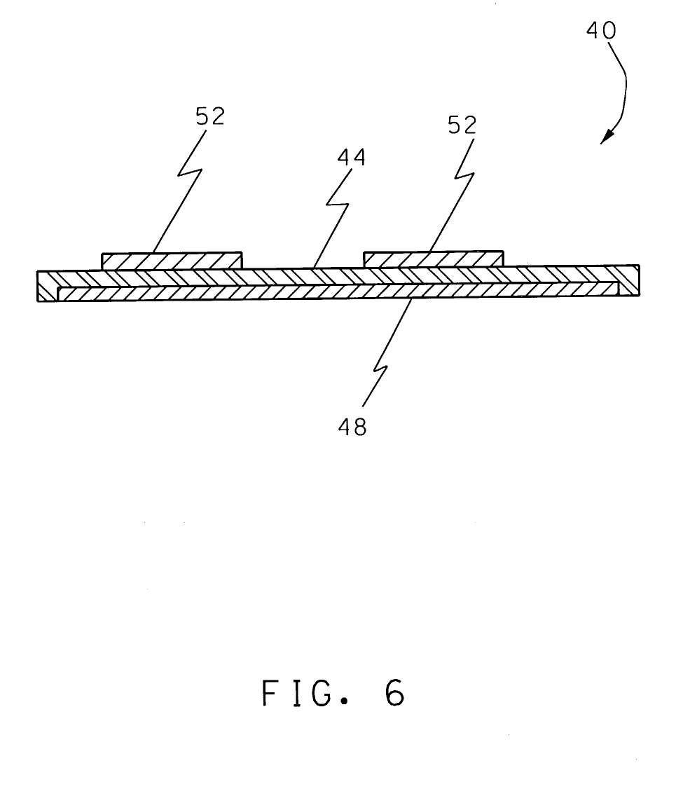

FIG. 5 shows a top view of a plurality of templates 18 being used in different capacities. The ruler template 18h is being used to hold the paper 14 in place and to allow the user to position the drawings in the desired place. The remaining templates 18 hold the non-magnetic template 28 in place, thereby enabling the user to concentrate on drawing or cutting at the desired location, without the fear that a slight movement of the hand will move the non-metallic template out of place. Additionally, one or more of the remaining templates can be used for drawing or cutting on the piece of paper.

Referring-now to FIG. 6, there is shown a cross-sectional view of a cutting surface, generally indicated at 40. The cutting surface 40 includes a shell portion 44 and a magnetic portion 48. The magnetic portion 48, which is preferably inset into the shell portion 44, can be formed from a magnetic or magnetized material, or from one or more pieces of ferrous metal.

As shown in FIG. 6, it is preferable that the magnetic portion 48 of the cutting surface 40 not extend to the edges of the cutting portion. While it is feasible to do so, having the shell portion 44 extend beyond the edges protects the edges of the magnetic portion 48 from damage. If desired, the magnetic portion 48 can be removable from the shell portion 44. The shell portion 44 and the magnetic portion 48 are preferably made so that one or both provides stiffness to the cutting surface 40.

The shell portion 44 can be made from a variety of materials. It is preferred, however, that a scratch or cut resistant plastic be used to minimize damage to the shell portion. It will be appreciated, however, that the shell portion 44 is generally inexpensive to make and can be replaced as necessary.

Disposed on the shell portion 44 are a pair of templates 52. Depending on the material which forms the magnetic portion, the templates 52 will either be a magnetic material, or a material which responds thereto, such as steel.

Thus, there is disclosed an improved template for making crafts supplies. Those skilled in the art will appreciate that numerous modifications can be made without departing from the skill or spirit of the invention. The appending claims are intended to cover such modification.

What is claimed is:

1. A template-cutting surface combination for cutting or drawing desired shapes on pieces of paper, the combination comprising a cutting surface formed from a durable material and a plurality of templates configured for holding a piece of paper on the cutting surface and for drawing a shape on the piece of paper, wherein one of the cutting surface and the template comprises a ferrous metal and wherein one of the cutting surface and the template comprise a magnetic or magnetized material.

2. The combination of claim 1 wherein the cutting surface is formed from steel.

3. The combination of claim 1 wherein the cutting surface has at least four times the surface area of the template.

4. The combination of claim 3 wherein the cutting surface has at least six times the surface area of the template.

5. The combination of claim 1, wherein at least one of the templates comprises a star.

6. The combination of claim 1, wherein at least one of the templates comprises a ruler.

7. The combination of claim 1, wherein at least one of the templates comprises a drawing of at least part of a person.

8. The combination of claim 1, wherein at least one of the templates has slots formed therein.

9. The combination of claim 1, wherein the cutting surface has a hole formed therein defining a handle.

10. The combination of claim 1, wherein the cutting surface is greater than 8.5 inches wide by 11 inches long.

11. The combination of claim 1, wherein the template is formed from a magnetic material.

12. The combination of claim 1, wherein the cutting surface comprises a magnetic material.

13. The combination of claim 1, wherein the template comprises steel.

14. A method for cutting paper into a desired shape, the method comprising,
selecting a cutting surface;
selecting a template which is magnetically attracted to the cutting surface; and
disposing a piece of paper between the template and the cutting surface so that the template holds the paper to the cutting surface; and
cutting the paper by tracing around the exterior of the cutting surface.

15. The method according to claim 14 wherein the template has a plurality of slots formed therein and wherein the method comprises cutting through the slots into the paper to access the paper.

16. The method according to claim 14, wherein the template comprises a star.

17. The method according to claim 14, wherein at least one of the templates comprises a ruler.

18. The method according to claim 14, wherein at least one of the templates comprises a drawing of at least part of a person.

19. The method according to claim 14, wherein the method comprises selecting a second template which is not magnetically attracted to the cutting surface and disposing the second template at least partially between the template and the cutting surface to magnetically hold the second template in place.

20. A method for drawing or cutting on a piece of paper, the method comprising:
disposing a piece of paper on a cutting surface made of a ferrous metal;
disposing a template on top of at least a portion of the paper to hold the paper in place, the template being formed from a magnetic material and having a plurality of ruled markings thereon.

21. The method according to claim 20, wherein the method comprises using the ruled markings on the template to space cuttings or drawings on the paper at a desired distance.

22. The method according to claim 20, further comprising disposing a non-metallic template on the paper.

23. The method according to claim 22, wherein the template having the ruled markings holds the non-metallic template to the paper.

24. The method according to claim 22, wherein the method comprises holding the non-metallic template to the paper by a plurality of metallic templates.

25. A method for making drawings on a piece of paper, the method comprising:
selecting a cutting surface formed from a ferrous metal;
selecting a plurality of metallic templates;
disposing a piece of paper on the cutting surface and holding the piece of paper to the cutting surface with the metallic templates.

26. The method of claim 25, wherein the method further comprises selecting a non-metallic template and using the metallic templates to the paper.

27. The method of claim 25, wherein at least one of the metallic template comprises a plurality of ruled markings for measuring distance.
